(19) United States
(12) Patent Application Publication
(10) Pub. No.: US 2025/0335797 A1
(43) Pub. Date: Oct. 30, 2025

(54) GENERATING IMAGE DESCRIPTIONS USING A MACHINE LEARNING MODEL

(71) Applicant: Lemon Inc., Grand Cayman (KY)

(72) Inventors: Xinyao Wang, Los Angeles, CA (US); Jiachen Li, Los Angeles, CA (US); Sijie Zhu, Los Angeles, CA (US); Chia-Wen Kuo, Los Angeles, CA (US); Lu Xu, Los Angeles, CA (US); Fan Chen, Los Angeles, CA (US); Longyin Wen, Los Angeles, CA (US)

(21) Appl. No.: 18/827,521

(22) Filed: Sep. 6, 2024

Related U.S. Application Data
(60) Provisional application No. 63/639,969, filed on Apr. 29, 2024.

(51) Int. Cl. G06N 5/043

(52) U.S. Cl. CPC G06N 5/043

(57) ABSTRACT

The present disclosure describes techniques for generating image descriptions using a machine learning model. Mixture of Experts (MoE) blocks are incorporated into a plurality of sub-models of the machine learning model. The first sub-model of the machine learning model comprises at least one first MoE block including a first plurality of experts. A second sub-model of the machine learning model comprises at least one second MoE block including a second plurality of experts. Only a subset of the first plurality of experts is activated to generate visual tokens based on an input image. Only a subset of the second plurality of experts is activated to project the visual tokens into an input space of the third sub-model. A text description of the input image is output by the third sub-model of the machine learning model.

### CROSS-REFENCE TO RELATED APPLICATION

The present disclosure claims priority to the U.S. Provisional Application No. 63/639,969, filed on Apr. 29, 2024, which is incorporated herein by reference in its entirety.

### BACKGROUND

Machine learning models are increasingly being used across a variety of industries to perform a variety of different tasks. Such tasks may include generating image descriptions. Improved techniques for utilizing machine learning models for image description generation are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for generating image descriptions using a machine learning model in accordance with the present disclosure.

FIG. 2 shows an example transformer block of a first sub-model in accordance with the present disclosure.

FIG. 3 shows an example system for generating image descriptions using a machine learning model in accordance with the present disclosure.

FIG. 4 shows an example three-stage training process in accordance with the present disclosure.

FIG. 5 shows an example process for generating image descriptions using a machine learning model in accordance with the present disclosure.

FIG. 6 shows an example process for generating visual tokens by a first sub-model in accordance with the present disclosure.

FIG. 7 shows an example process for generating visual tokens by a first sub-model in accordance with the present disclosure.

FIG. 8 shows an example process for processing visual tokens by a second sub-model in accordance with the present disclosure.

FIG. 9 shows an example process for generating image descriptions using a machine learning model in accordance with the present disclosure.

FIG. 10 shows an example process for generating image descriptions using a machine learning model in accordance with the present disclosure.

FIG. 11 shows an example process for training a machine learning model in accordance with the present disclosure.

FIG. 12 shows an example process for training a machine learning model in accordance with the present disclosure.

FIG. 13 shows an example table illustrating performance data in accordance with the present disclosure.

FIG. 14A shows an example table illustrating score data in accordance with the present disclosure.

FIG. 14B shows an example table illustrating score data in accordance with the present disclosure.

FIG. 15 shows an example table illustrating performance data in accordance with the present disclosure.

FIG. 16A shows an example table illustrating performance data in accordance with the present disclosure.

FIG. 16B shows an example table illustrating performance data in accordance with the present disclosure.

FIG. 16C shows an example table illustrating performance data in accordance with the present disclosure.

FIG. 17 shows an example computing device which may be used to perform any of the techniques disclosed herein.

### DETAILED DESCRIPTION OF ILLUSTRATIVE EMBODIMENTS

In natural language processing domain, a large language model can be based on a transformer architecture. Many multimodal machine learning models leverage pre-trained vision encoders to provide visual content and enable their visual capacities. But it can be difficult to scale up multimodal large language models. As such, techniques for improving multimodal large language models are needed.

Described herein are improved techniques for improving a multimodal machine learning model. The techniques described herein incorporate Top-K sparsely gated Mixture-of-Experts (MoE) blocks into each sub-model of a multimodal machine learning model. For example, MoE blocks are incorporated into a vision encoder, a multilayer perceptron (MLP) connector, and a large language model of a multimodal machine learning model to enhance capabilities of the multimodal machine learning model.

The multimodal machine learning model can be trained using a three-stage training process with auxiliary losses to stabilize the training and maintain a balanced loading of experts. The first stage of the three-stage training process can include pre-training the MLP connector of the multimodal machine learning model. The second stage of the three-stage training process can include warming up the whole multimodal machine learning model through pre-finetuning. The pre-finetuning stabilizes a third stage of the three-stage training process with added MoE blocks. During the third stage, each MLP block in each sub-model can be replaced with the Top-K sparsely-gated MoE block through co-upcycling. Each MoE block of each sub-model can be initialized from a corresponding MLP that is well-trained by the first stage and/or the second stage. Each MoE block can include a Top-K router that is trained from scratch to select MLP experts during the third stage.

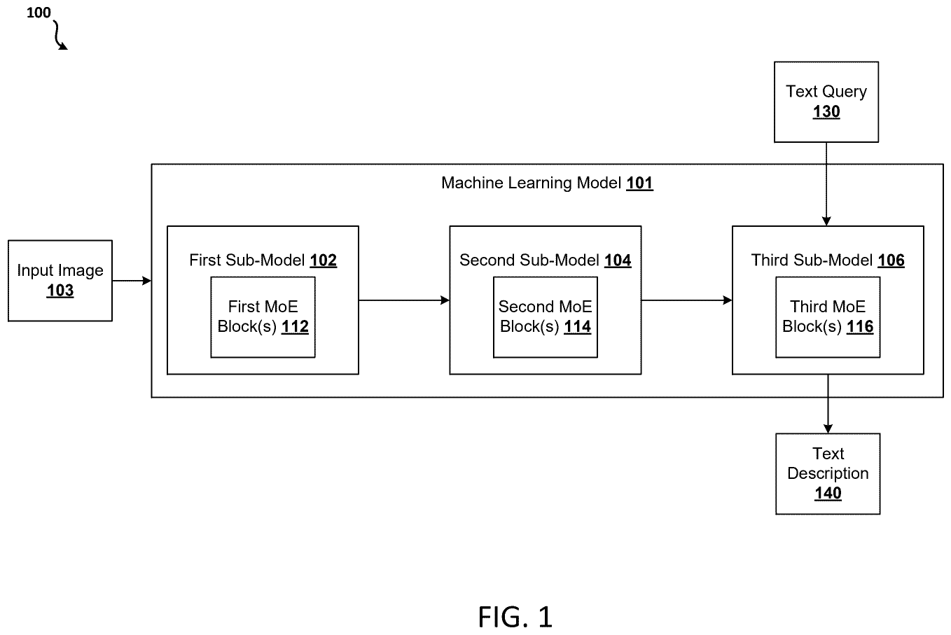

FIG. 1 illustrates an example system 100 in accordance with the present disclosure. The system 100 can include a machine learning model 101. The machine learning model 101 can include a first sub-model 102. The first sub-model 102 can include a contrastive language-image pretraining (CLIP) vision encoder. The machine learning model 101 can include a second sub-model 104. The second sub-model 104 can include an MLP connector. The machine learning model 101 can include a third sub-model 106. The third sub-model 106 can include a large language model.

The machine learning model 101 can be configured by incorporating Mixture of Experts (MoE) blocks into each of the first sub-model 102, the second sub-model 104, and the third sub-model 106. For example, at least one first MoE block 112 can be incorporated into the first sub-model 102. Each of the first MoE block(s) 112 can include a first plurality of experts. An MoE block can be incorporated into each layer of the first sub-model 102. At least one second MoE block 114 can be incorporated into the second sub-model 104. Each of the second MoE block(s) 114 can include a second plurality of experts. An MoE block can be incorporated into each layer of the second sub-model 104. At least one third MoE block 116 can be incorporated into the third sub-model 106. Each of the third MoE block(s) 116 can include a third plurality of experts. An MoE block can be incorporated into each layer of the third sub-model 106.

The machine learning model 101 can receive, as input, an input image 103. The first sub-model 102 can receive the input image 103. The first sub-model 102 can generate visual tokens based on the input image 103. To generate the visual tokens based on the input image 103, the first sub-model 102 can generate representations of the input image 103 based on performing self-attention and normalization. The representations of the input image 103 can be routed to a subset of the first plurality of experts (e.g., by a router of the at least one first MoE block 112). Only the subset of the first plurality of experts in the at least one first MoE block 112 can be activated to process the representations for generating the visual tokens. The subset of the first plurality of experts can include those experts from the first plurality of experts that are most capable of performing the visual token generation task (e.g., the experts from the first plurality of experts that are able to generate the best visual tokens). The subset of the first plurality of experts can include any number K of experts from the first plurality of experts, such as the Top-K experts. The visual tokens can be generated by calculating a weighted sum of outputs from the activated subset of the first plurality of experts. The remainder of the experts in the first plurality of experts can remain de-activated (e.g., idle) during generation of the visual tokens.

The second sub-model 104 can receive the visual tokens. The second sub-model 104 can project the visual tokens into a latent input space of the third sub-model 106 so that they are consumable by the third sub-model 106. To project the visual tokens into the latent input space of the third sub-model 106, the visual tokens can be routed to a subset of the second plurality of experts (e.g., by a router of the at least one second MoE block 114). Only the subset of the second plurality of experts in the at least one second MoE block 114 can be activated to process the visual tokens and project the visual tokens into the latent input space of the third sub-model 106. The subset of the second plurality of experts can include those experts from the second plurality of experts that are most capable of processing the visual tokens. The subset of the second plurality of experts can include any number K of experts from the second plurality of experts, such as the Top-K experts. A weighted sum of outputs from the activated subset of the second plurality of experts can be calculated. The weighted sum of the outputs can be projected into the latent input space of the third sub-model 106. The remainder of the experts in the second plurality of experts can remain de-activated (e.g., idle) during processing of the visual tokens.

The third sub-model 106 can receive the projected visual tokens. The third sub-model 106 can further receive an embedding associated with a text query 130. The embedding associated with a text query 130 can be in the same space as the projected visual tokens. The text query 130 can include a user query indicating a question to be answered about the input image 103 and/or any other natural language task to be performed with respect to the input image 103.

The third sub-model 106 can generate a text description 140 of the input image 103 based on the projected visual tokens and/or the embedding associated with the text query 130. The text description 140 of the input image 103 can be responsive to the text query 130. To generate the text description, the projected visual tokens and/or the embedding can be routed to a subset of the third plurality of experts (e.g., by a router of the at least one third MoE block 116). Only the subset of the third plurality of experts in the at least one third MoE block 116 can be activated to process the projected visual tokens and/or the embedding for generating the text description 140. The subset of the third plurality of experts can include those experts from the third plurality of experts that are most capable of processing the projected visual tokens and/or the embedding (e.g., the experts from the third plurality of experts that are able to generate the best text description 140). The subset of the third plurality of experts can include any number K of experts from the third plurality of experts, such as the Top-K experts. A weighted sum of outputs from the activated subset of the third plurality of experts can be calculated. The weighted sum of the outputs can be used to generate the text description 140. The third sub-model 106 can output the generated text description 140. The remainder of the experts in the third plurality of experts can remain de-activated (e.g., idle) during generation of the text description 140.

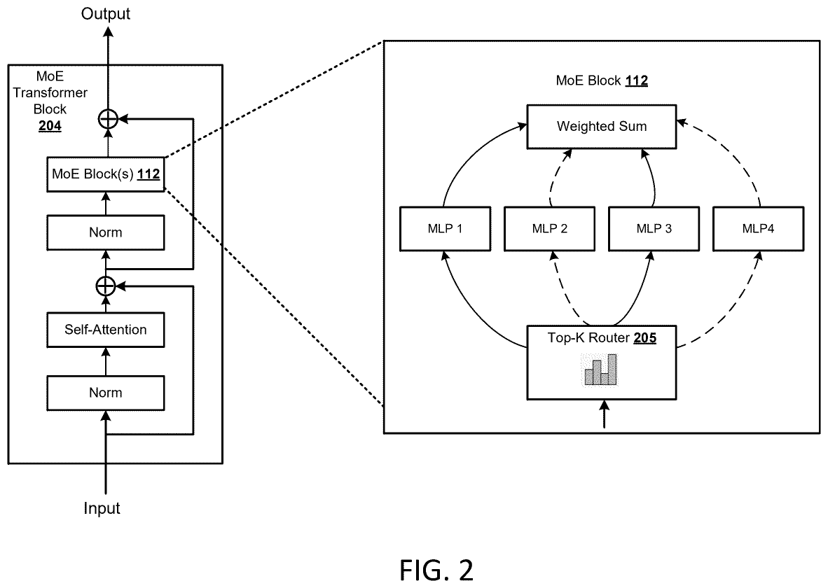

FIG. 2 illustrates an example MoE transformer block 204 of the first sub-model 102. The first sub-model 102 can include a plurality of transformer blocks with MoE blocks (e.g., one in each layer of the first sub-model 102). Each transformer block may resemble the example MoE-based transformer block 204 shown in FIG. 2. Each transformer block can be configured to performing self-attention and normalization to generate representations of an input image (e.g., the input image 103) before the representations reach the MoE block 112. The MoE block 112 can include a Top-K router 205. The Top-K router 205 can select the Top-K MLP expert candidates. In the example of FIG. 2, the Top-K router 205 can select MLP 1 and MLP 3 as the Top-K MLP expert candidates. Only MLP 1 and MLP 3 can be activated to process the representations for generating the visual tokens. The visual tokens can be generated by calculating a weighted sum of outputs from MLP 1 and MLP 3. The remainder of the experts (e.g., MLP 2 and MLP 4) in the first plurality of experts can remain de-activated (e.g., idle) during generation of the visual tokens.

In embodiments, the Top-K router 205 can select the Top-K MLP expert candidates out of S total experts, which adopts a linear layer to compute the normalized weight matrix W based on the inputs W for voting:

$$W = Soft max ( Linear ( W ) ) ∈ {R}^{N \times S}$$

Then, the Top-K MLP experts can be selected for each token based on W and the re-normalized weights W_{K}∈R^{N×K} are computed by:

$${W}_{K} = Soft max ( Top K ( W ) ) ∈ {R}^{N \times K}$$

Each selected expert can be an MLP block, and the final output can be a re-weighted sum:

$${x}_{out} = {\sum }_{i}^{K} {W}_{K}^{i} ∘ {MLP}_{i} ( X ) ∈ {R}^{N \times {C}_{out}}$$

where the output Xₒᵤₜ has the same dimension as the output of a single dense MLP block.

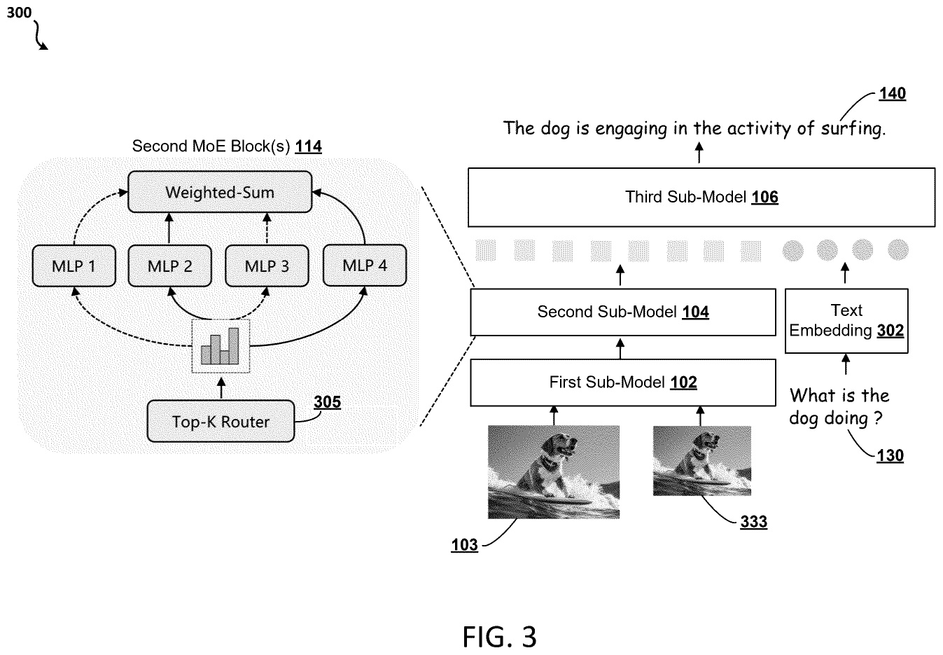

FIG. 3 illustrates an example system 300 in accordance with the present disclosure. The system 300 can include the first sub-model 102, the second sub-model 104, and the third sub-model 106. As described above with regard to FIGS. 1-2, the first sub-model 102 can include one or more first MoE blocks 112. For example, the visual encoding part of the first sub-model 102 can include a transformer model, which can include consecutive MLP blocks in the transformer encoder. Each single MLP block can be replaced with a Top-K sparse MoE block. The skip connection, along with the outputs of the MoE block, can be kept.

The second sub-model 104 can include one or more second MoE block(s) 114. Each MoE block 114 can include a Top-K router 305. The Top-K router 305 can select the Top-K MLP expert candidates. In the example of FIG. 3, the Top-K router 305 can select MLP 2 and MLP 4 as the Top-K MLP expert candidates. Only MLP 2 and MLP 4 can be activated to process the visual tokens generated by the first sub-model 102 and project the visual tokens into the latent input space of the third sub-model 106. The remainder of the experts (e.g., MLP 1 and MLP 3) in the second plurality of experts can remain de-activated (e.g., idle) during processing of the visual tokens.

For example, the Top-K router 305 can select the Top-K MLP expert candidates out of S total experts, which adopts a linear layer to compute the normalized weight matrix W based on the inputs W for voting:

$$W = Soft max ( Linear ( W ) ) ∈ {R}^{N \times S}$$

Then, the Top-K MLP experts can be selected for each token based on W and the re-normalized weights W_{K}∈R^{N×K} are computed by:

$${W}_{K} = Soft max ( Top K ( W ) ) ∈ {R}^{N \times K}$$

Each selected expert can be an MLP block, and the final output can be a re-weighted sum:

$${x}_{out} = {\sum }_{i}^{K} {W}_{K}^{i} ∘ {MLP}_{i} ( X ) ∈ {R}^{N \times {C}_{out}}$$

where the output Xₒᵤₜ has the same dimension as the output of a single dense MLP block.

The third sub-model 106 can generate the text description 140 of the input image 103 based on the projected visual tokens and/or an embedding 302 associated with the text query 130. The text description 140 of the input image 103 can be responsive to the text query 130. To generate the text description, the projected visual tokens and/or the embedding 302 can be routed to a subset of the third plurality of experts (e.g., by a router of the at least one third MoE block 116). Only the subset of the third plurality of experts in the at least one third MoE block 116 can be activated to process the projected visual tokens and/or the embedding 302 for generating the text description 140.

In embodiments, high-resolution inputs are essential for the third sub-model 106 to understand the details of the input image 103. However, simply extending the number of visual tokens by taking in high-resolution inputs of images significantly increases the training and inference costs. For instance, given an image of 336×336 as inputs, the first sub-model 102 can convert it to 576 tokens while inputs of 672×672 are equivalent to 2304 tokens. To remedy this issue, the input image 103 can be scaled to multi-resolution pyramid images (e.g., image 333). The multi-resolution pyramid images can be sent to the first sub-model 102. The first sub-model 102 can returns a pyramid of multi-resolution visual features. Then, the high-resolution feature maps can be down-sampled and concatenated channel-wise before being sent to the second sub-model 104. As a result, the number of visual tokens (e.g., 576) is maintained while leveraging the multi-resolution inputs.

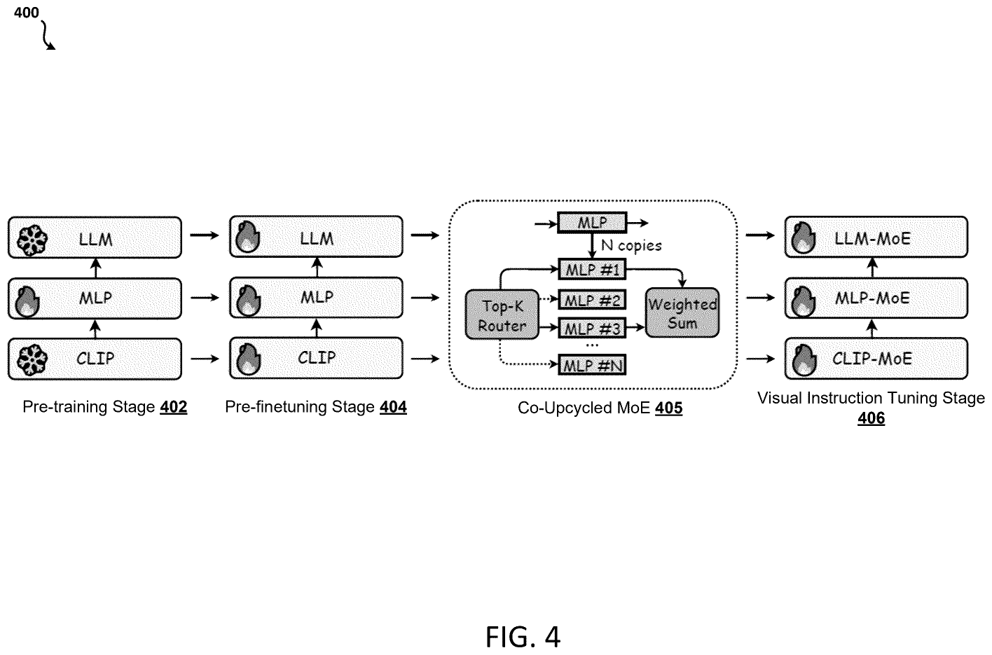

FIG. 4 shows an example three-stage training process 400 for training the machine learning model 101. To smooth the training stability during training of the machine learning model 101, the three-stage training process 400 can be adopted. The three-stage training process 400 includes a pre-training stage 402, a pre-finetuning stage 404, and a visual instruction tuning stage 406. During the pre-training stage 402, the second sub-model 104 (e.g., an MLP connector) can be pre-trained, while keeping the first sub-model 102 (e.g., a vision encoder) and the third sub-model 106 (e.g., a large language model) frozen. The first sub-model 102 and the third sub-model 106 can be pre-trained on large-scale data. During the pre-finetuning stage 404, the parameters of the machine learning model 101 can be fine-tuned with caption data to warm up the entire machine learning model 101 before adding the MoE blocks in the visual instruction tuning stage 406. For example, parameters of each of the first sub-model 102, the second sub-model 104, and the third sub-model 106 can be fine-tuned during the pre-finetuning stage 404.

During the visual instruction tuning stage 406, the machine learning model 101 is scaled up with upcycled MoE blocks and trained under visual instruction tuning data. Scaling up the machine learning model 101 with the upcycled MoE blocks can include adding at least one MoE block into each of the first sub-model 102, the second sub-model 104, and the third sub-model 106. Adding at least one MoE block into each of the first sub-model 102, the second sub-model 104, and the third sub-model 106 can include generating an initial, well-trained expert for each of the first sub-model 102, the second sub-model 104, and the third sub-model 106 based on the pre-finetuned parameters.

For example, an initial expert in each MoE block of the first sub-model can be a MLP of the first sub-model that has been well-trained in the second pre-finetuning stage. An initial expert of the second sub-model can be a MLP of the second sub-model that has been well-trained in the first pre-training and second pre-finetuning stages. An initial expert in each MoE block of the third sub-model can be a MLP that has been well-trained in the second pre-finetuning stage. The initial, well-trained expert for each of the first sub-model 102, the second sub-model 104, and the third sub-model 106 can be replicated (e.g., copied) a number N times to generate at least one initial expert block 405 for each of the first sub-model 102, the second sub-model 104, and the third sub-model 106.

Before training the machine learning model 101 with the visual instruction tuning data, the initial expert block 405 in each of the first sub-model 102, the second sub-model 104, and the third sub-model 106 can include N exact replicas of the corresponding initial expert. Then, each of the first sub-model 102, the second sub-model 104, and the third sub-model 106 can be iteratively trained with the visual instruction tuning data. For example, the at least one first MoE block 112 can be obtained by iteratively training the at least one initial expert block for the first sub-model 102. The at least one second MoE block 114 can be obtained by iteratively training the at least one initial expert block for the second sub-model 104.The at least one third MoE block can be obtained by iteratively training the at least one initial expert block for the third sub-model. During each iteration, different experts in the initial expert block 405 can be activated to process different data. In this manner, by the end of the visual instruction tuning stage 406, the experts in each expert block will have different parameters.

In embodiments, to maintain a load balance between experts in each MoE block during the visual instruction tuning stage, auxiliary losses can be adopted based on the language modeling cross-entropy loss. The auxiliary losses can include a loading balance loss and a router z-loss. As a result, the total loss L can be:

$$L = {L}_{ce} + {α}_{b} {L}_{b} + {α}_{z} {L}_{Z} .$$

The language modeling loss L_{ce} is the cross-entropy of the next-token predictions, while α_{b} and α_{z} are coefficients of the loading balance loss L_{b} and the router z-loss L_{z}, respectively. The auxiliary losses can be referred to herein as “bzloss” for simplicity. The auxiliary losses can be applied to the first sub-model 102, the second sub-model 104, and the third sub-model 106 separately.

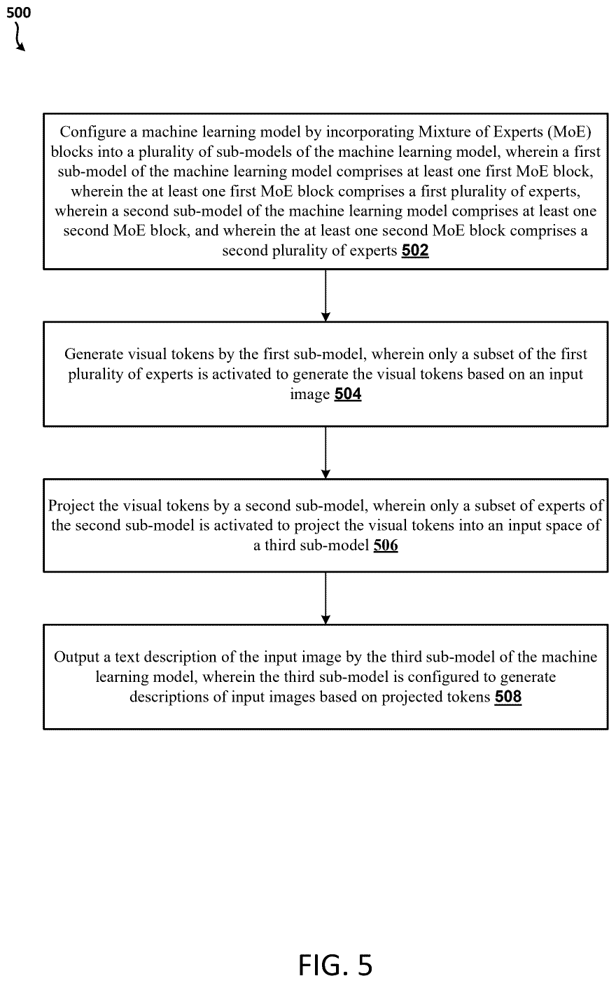

FIG. 5 shows an example process 500 for generating image descriptions using a machine learning model. Although depicted as a sequence of operations in FIG. 5, those of ordinary skill in the art will appreciate that various embodiments may add, remove, reorder, or modify the depicted operations.

At 502, a machine learning model (e.g., the machine learning model 101) can be configured. The machine learning model can be configured by incorporating Mixture of Experts (MoE) blocks into a plurality of sub-models (e.g., first sub-model 102, second sub-model 104, and/or third sub-model 106) of the machine learning model. The first sub-model can include a contrastive language-image pretraining (CLIP) vision encoder. The first sub-model of the machine learning model can include at least one first MoE block (e.g., first MoE block(s) 112). The at least one first MoE block can include first plurality of experts. The second sub-model can include an MLP connector. The second sub-model of the machine learning model can include at least one second MoE block (e.g., second MoE block(s) 114). The at least one second MoE block can include a second plurality of experts. The third sub-model can include a large language model.

At 504, visual tokens can be generated by the first sub-model. The visual tokens can be generated based on an input image (e.g., input image 103). Only a subset of the first plurality of experts in the at least one first MoE block can be activated to generate the visual tokens. The subset of the first plurality of experts can include those experts from the first plurality of experts that are most capable of performing the visual token generation task (e.g., the experts from the first plurality of experts that are able to generate the best visual tokens). The subset of the first plurality of experts can include any number K of experts from the first plurality of experts, such as the Top-K experts. The remainder of the experts in the first plurality of experts can remain de-activated (e.g., idle) during generation of the visual tokens.

At 506, the visual tokens can be projected by the second sub-model. Only a subset of the second plurality of experts in the at least one second MoE block can be activated to project the visual tokens into an input space of the third sub-model. The subset of the second plurality of experts can include those experts from the second plurality of experts that are most capable of projecting the visual tokens into the input space of the third sub-model. The subset of the second plurality of experts can include any number K of experts from the second plurality of experts, such as the Top-K experts. The remainder of the experts in the second plurality of experts can remain de-activated (e.g., idle) during projection of the visual tokens.

At 508, a text description (e.g., text description 140) of the input image can be output by the third-sub model. The third sub-model can generate the text description of the input image based on the projected visual tokens. The third sub-model can be configured to generate and output descriptions of input images based on projected tokens.

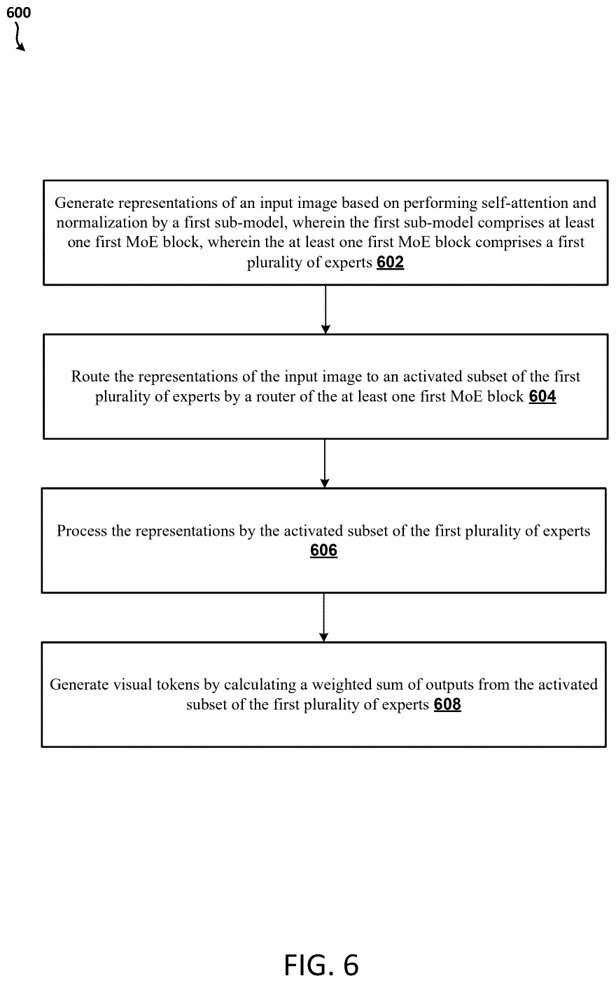

FIG. 6 shows an example process 600 for generating visual tokens by a first sub-model of a machine learning model. Although depicted as a sequence of operations in FIG. 6, those of ordinary skill in the art will appreciate that various embodiments may add, remove, reorder, or modify the depicted operations.

A machine learning model (e.g., machine learning model 101) can receive, as input, an input image (e.g., input image 103). A first sub-model (e.g., first sub-model 102) of the machine learning model can receive the input image. At 602, representations of the input image can be generated. The representations of the input image can be generated based on performing self-attention and normalization by the first sub-model. The first sub-model can include at least one first MoE block (e.g., first MoE block(s) 112). The at least one first MoE block can include a first plurality of experts.

At 604, the representations of the input image can be routed to an activated subset of the first plurality of experts. The representations of the input image can be routed to the activated subset of the first plurality of experts by a router (e.g., Top-K router 205) of the at least one first MoE block. Only the subset of the first plurality of experts in the at least one first MoE block can be activated to process the representations. The subset of the first plurality of experts can include those experts from the first plurality of experts that are most capable of performing a visual token generation task (e.g., the experts from the first plurality of experts that are able to generate the best visual tokens). The subset of the first plurality of experts can include any number K of experts from the first plurality of experts, such as the Top-K experts. At 606, the representations can be processed by the activated subset of the first plurality of experts. At 608, visual tokens can be generated. The visual tokens can be generated by calculating a weighted sum of outputs from the activated subset of the first plurality of experts in the first sub-model. The remainder of the experts in the first plurality of experts can remain de-activated (e.g., idle) during generation of the visual tokens by the first sub-model.

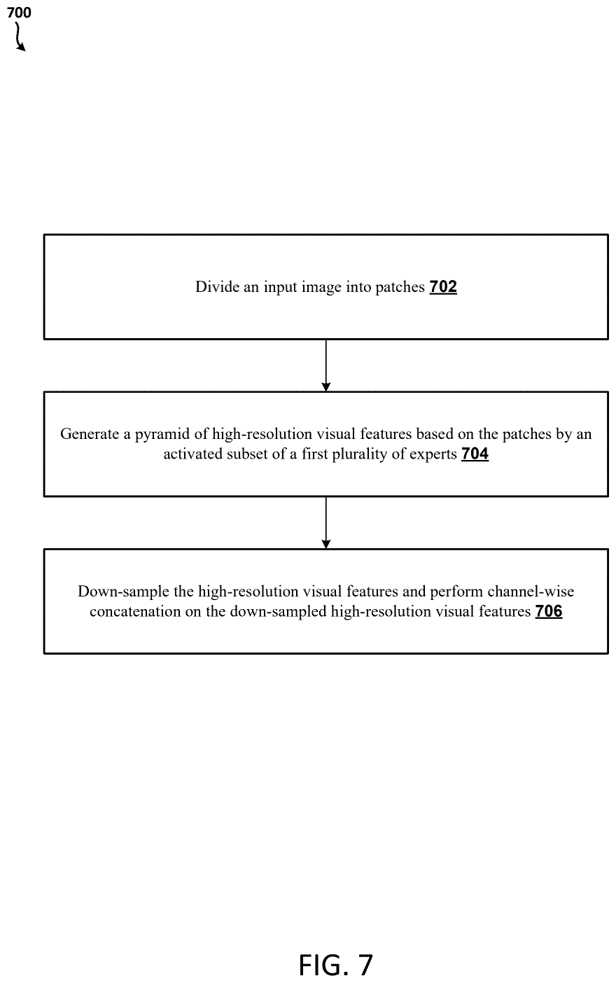

FIG. 7 shows an example process 700 for generating visual tokens by a first sub-model of a machine learning model. Although depicted as a sequence of operations in FIG. 7, those of ordinary skill in the art will appreciate that various embodiments may add, remove, reorder, or modify the depicted operations.

In embodiments, high-resolution inputs are essential for a third sub-model (e.g., third sub-model 106) of a machine learning model (e.g., machine learning model 101) to understand the details of an input image (e.g., input image 103). At 702, an input image can be divided into patches (e.g., multi-resolution pyramid images). The patches can be sent to a first sub-model (e.g., the first sub-model 102). At 704, the first sub-model can generate a pyramid of multi-resolution visual features based on the patches. For example, only the activated subset of the first plurality of experts of the first sub-model can generate the pyramid of multi-resolution visual features based on the patches. At 706, the high-resolution feature maps can be down-sampled and concatenated channel-wise before being sent to a second sub-model (e.g., second sub-model 104). As a result, the number of visual tokens can be maintained while leveraging the multi-resolution inputs.

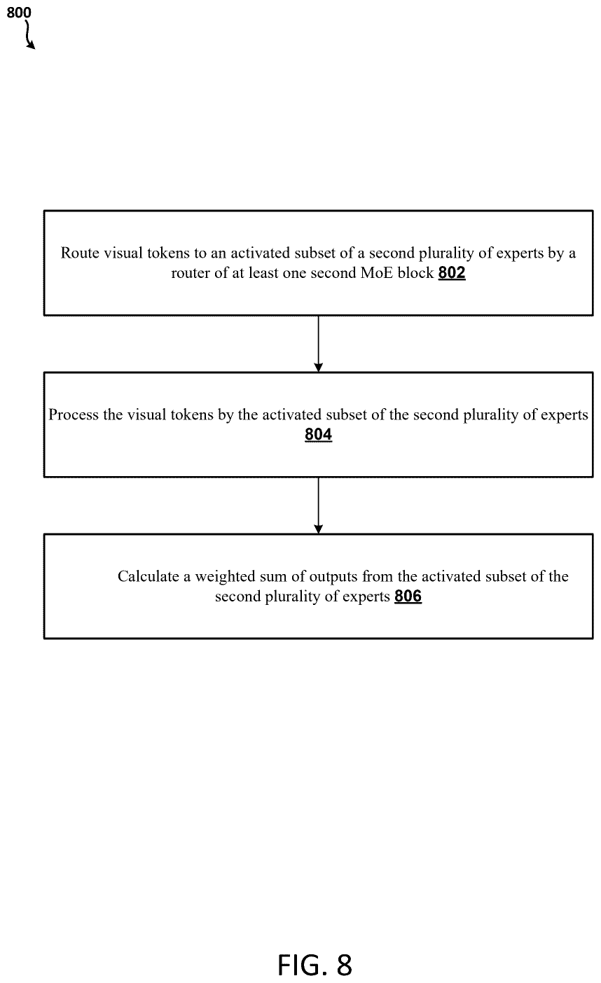

FIG. 8 shows an example process 800 for processing visual tokens by a second sub-model. Although depicted as a sequence of operations in FIG. 8, those of ordinary skill in the art will appreciate that various embodiments may add, remove, reorder, or modify the depicted operations.

A machine learning model (e.g., machine learning model 101) can receive, as input, an input image (e.g., input image 103). A first sub-model (e.g., first sub-model 102) can receive the input image. The first sub-model can generate visual tokens based on the input image. A second sub-model (e.g., second sub-model 104) of the machine learning model can receive the visual tokens. The second sub-model can include at least one second MoE block (e.g., second MoE block(s) 114). The at least one second MoE block of the second sub-model can include a second plurality of experts.

At 802, the visual tokens can be routed to an activated subset of the second plurality of experts by a router (e.g., Top-K router 305) of the at least one second MoE block. Only the subset of the second plurality of experts in the at least one second MoE block can be activated to process the visual tokens. The subset of the second plurality of experts can include those experts from the second plurality of experts that are most capable of processing the visual tokens. The subset of the second plurality of experts can include any number K of experts from the second plurality of experts, such as the Top-K experts. At 804, the subset of the second plurality of experts can process the visual tokens. The remainder of the experts in the second plurality of experts can remain de-activated (e.g., idle) during processing of the visual tokens. At 806, a weighted sum of outputs from the activated subset of the second plurality of expert can be calculated as the token projected in the input space of the third sub-model. The projected tokens can be consumable by the third sub-model of the machine learning model.

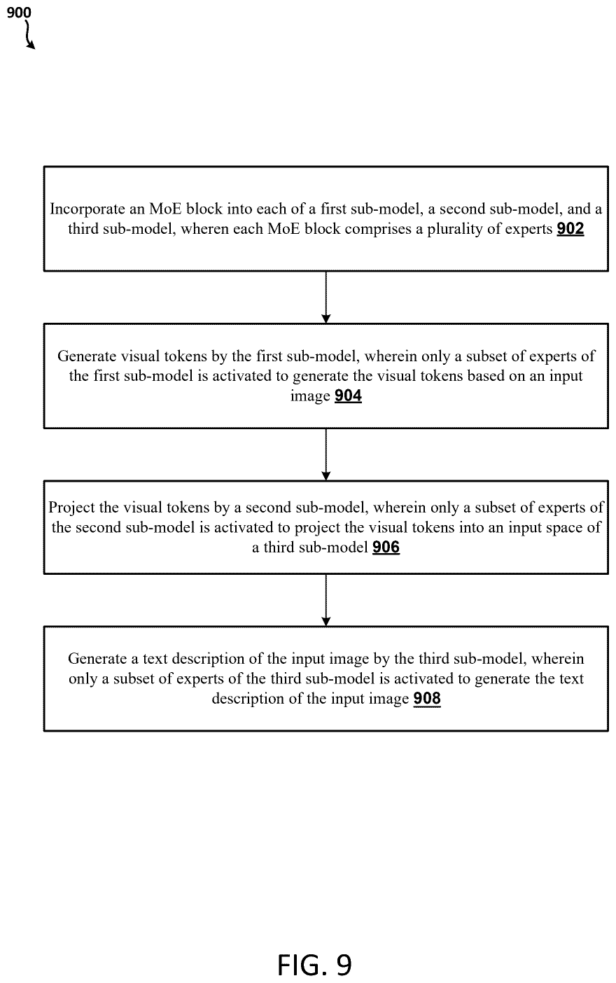

FIG. 9 shows an example process 900 for generating image descriptions using a machine learning model. Although depicted as a sequence of operations in FIG. 9, those of ordinary skill in the art will appreciate that various embodiments may add, remove, reorder, or modify the depicted operations.

At 902, a machine learning model (e.g., the machine learning model 101) can be configured. The machine learning model can be configured by incorporating Mixture of Experts (MoE) blocks into a plurality of sub-models (e.g., first sub-model 102, second sub-model 104, and/or third sub-model 106) of the machine learning model. The first sub-model can include a contrastive language-image pretraining (CLIP) vision encoder. At least one first MoE block (e.g., first MoE block(s) 112) can be incorporated into the first sub-model. The at least one first MoE block can include first plurality of experts. The second sub-model can include an MLP connector. At least one second MoE block (e.g., second MoE block(s) 114) can be incorporated into the second sub-model. The at least one second MoE block can include a second plurality of experts. The third sub-model can include a large language model. At least one third MoE block (e.g., third MoE block(s) 116) can be incorporated into the third sub-model. The at least one third MoE block can include a third plurality of experts.

At 904, visual tokens can be generated by the first sub-model. The visual tokens can be generated based on an input image (e.g., input image 103). Only a subset of the first plurality of experts in the at least one first MoE block can be activated to generate the visual tokens. The subset of the first plurality of experts can include those experts from the first plurality of experts that are most capable of performing the visual token generation task (e.g., the experts from the first plurality of experts that are able to generate the best visual tokens). The subset of the first plurality of experts can include any number K of experts from the first plurality of experts, such as the Top-K experts. The remainder of the experts in the first plurality of experts can remain de-activated (e.g., idle) during generation of the visual tokens.

At 906, the visual tokens can be projected into an input space of the third sub-model by the second sub-model. Only a subset of the second plurality of experts in the at least one second MoE block can be activated to project the visual tokens into the input space of the third sub-model. The subset of the second plurality of experts can include those experts from the second plurality of experts that are most capable of projecting the visual tokens into the input space of the third sub-model. The subset of the second plurality of experts can include any number K of experts from the second plurality of experts, such as the Top-K experts. The remainder of the experts in the second plurality of experts can remain de-activated (e.g., idle) during projection of the visual tokens by the second sub-model.

At 908, a text description (e.g., text description 140) of the input image can be generated by the third-sub model. Only a subset of the third plurality of experts in the at least one third MoE block can be activated to generate the text description based on the projected tokens. The subset of the third plurality of experts can include those experts from the third plurality of experts that are most capable of generating the text description. The subset of the third plurality of experts can include any number K of experts from the third plurality of experts, such as the Top-K experts. The remainder of the experts in the third plurality of experts can remain de-activated (e.g., idle) during generation of the text description by the third sub-model.

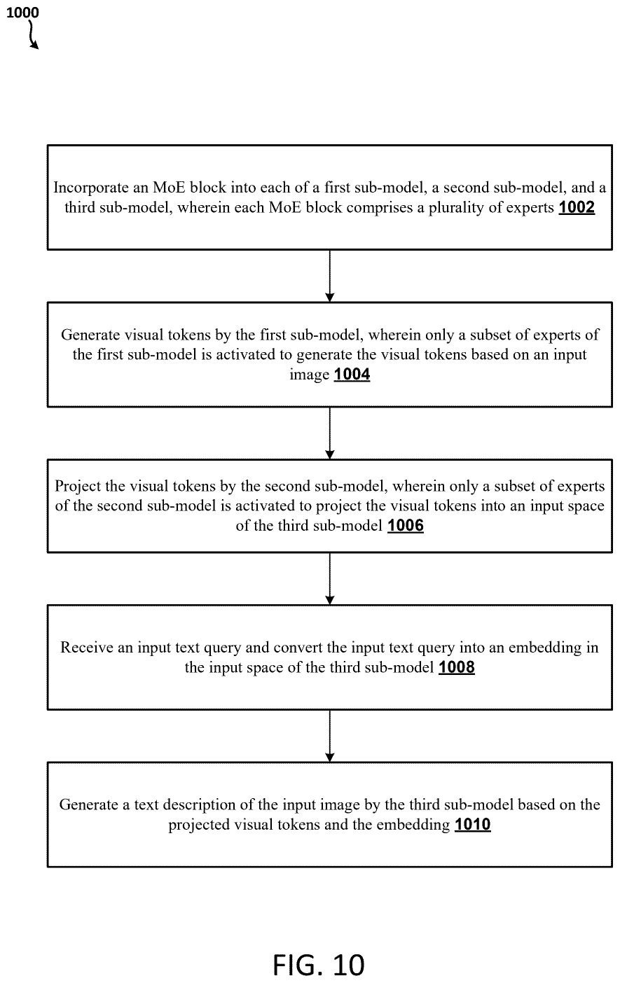

FIG. 10 shows an example process 1000 for generating image descriptions using a machine learning model. Although depicted as a sequence of operations in FIG. 10, those of ordinary skill in the art will appreciate that various embodiments may add, remove, reorder, or modify the depicted operations.

At 1002, a machine learning model (e.g., the machine learning model 101) can be configured. The machine learning model can be configured by incorporating Mixture of Experts (MoE) blocks into a plurality of sub-models (e.g., first sub-model 102, second sub-model 104, and/or third sub-model 106) of the machine learning model. The first sub-model can include a contrastive language-image pretraining (CLIP) vision encoder. At least one first MoE block (e.g., first MoE block(s) 112) can be incorporated into the at least one first MoE block. The at least one first MoE block can include first plurality of experts. The second sub-model can include an MLP connector. At least one second MoE block (e.g., second MoE block(s) 114) can be incorporated into the second sub-model. The at least one second MoE block can include a second plurality of experts. The third sub-model can include a large language model. At least one third MoE block (e.g., third MoE block(s) 116) can be incorporated into the third sub-model. The at least one third MoE block can include a third plurality of experts.

At 1004, visual tokens can be generated by the first sub-model. The visual tokens can be generated based on an input image (e.g., input image 103). Only a subset of the first plurality of experts in the at least one first MoE block can be activated to generate the visual tokens. The subset of the first plurality of experts can include those experts from the first plurality of experts that are most capable of performing the visual token generation task (e.g., the experts from the first plurality of experts that are able to generate the best visual tokens). The subset of the first plurality of experts can include any number K of experts from the first plurality of experts, such as the Top-K experts. The remainder of the experts in the first plurality of experts can remain de-activated (e.g., idle) during generation of the visual tokens.

At 1006, the visual tokens can be projected into an input space of the third sub-model by the second sub-model. Only a subset of the second plurality of experts in the at least one second MoE block can be activated to project the visual tokens into the input space of the third sub-model. The subset of the second plurality of experts can include those experts from the second plurality of experts that are most capable of projecting the visual tokens into the input space of the third sub-model. The subset of the second plurality of experts can include any number K of experts from the second plurality of experts, such as the Top-K experts. The remainder of the experts in the second plurality of experts can remain de-activated (e.g., idle) during projection of the visual tokens.

The third sub-model can receive the projected visual tokens. At 1008, a text query (e.g., text query 130) may be received by the machine learning model. The text query can include a user query indicating a question to be answered about the input image and/or any other natural language task to be performed with respect to the input image. The text query can be converted into an embedding (e.g., embedding 302). The embedding can be in the same space as the projected visual tokens. The text embedding can input to the third sub-model. At 1010, a text description (e.g., text description 140) of the input image can be generated by the third-sub model. The third sub-model can generate the text description of the input image based on the projected visual tokens and the text embedding.

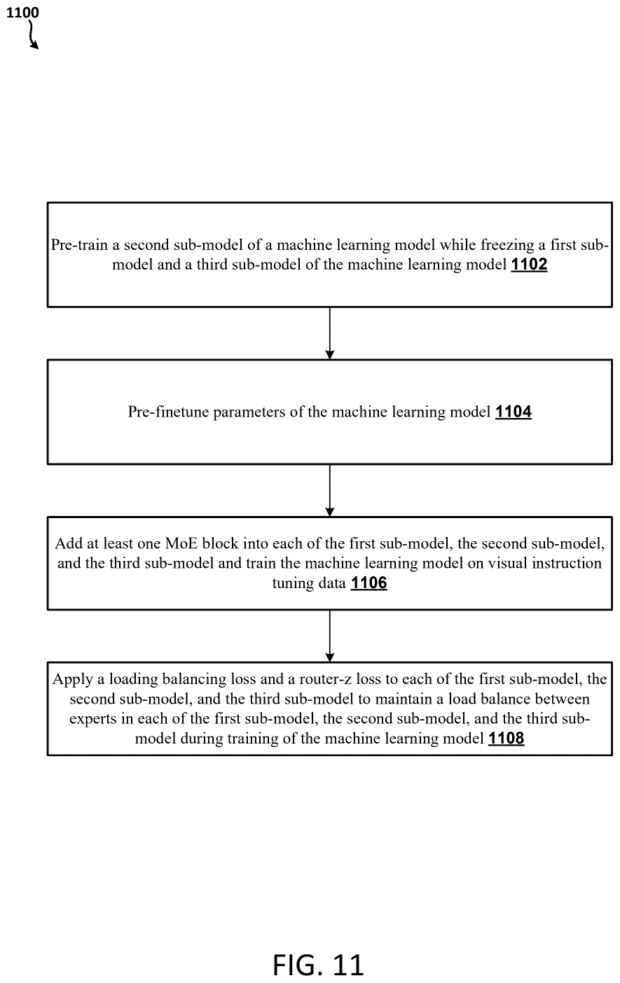

FIG. 11 shows an example process 1100 for training a machine learning model. Although depicted as a sequence of operations in FIG. 11, those of ordinary skill in the art will appreciate that various embodiments may add, remove, reorder, or modify the depicted operations.

To smooth the training stability during training of a machine learning model (e.g., machine learning model 101), a three-stage training process can be adopted. The three-stage training process comprises a first training stage, a second training stage, and a third training stage. For example, the three-stage training process can include a pre-training stage (e.g., the pre-training stage 402) as the first training stage. At 1102, a second sub-model (e.g., second sub-model 104) of the machine learning model can be pre-trained while freezing a first sub-model (e.g., first sub-model 102) and a third sub-model (e.g., third sub-model 106) of the machine learning model.

The three-stage training process can include a pre-finetuning stage (e.g., the pre-finetuning stage 404) as the second training stage. At 1104, the parameters of the machine learning model can be pre-finetuned to warm up the entire machine learning model before adding the MoE blocks. The parameters of each of the first sub-model, the second sub-model, and the third sub-model can be pre-finetuned. The three-stage training process can include a pre-finetuning stage visual instruction tuning stage (e.g., the visual instruction tuning stage 406) as the third training stage. At 1106, at least one MoE block can be added into each of the first sub-model, the second sub-model, and the third sub-model during the visual instruction tuning stage. The machine learning model can be trained on visual instruction tuning data. At 1108, auxiliary losses can be adopted to maintain a load balance between experts in each MoE block during the visual instruction tuning stage. A loading balancing loss and a router-z loss can be applied to each of the first sub-model, the second sub-model, and the third sub-model to maintain a load balance between experts in each of the first sub-model, the second sub-model, and the third sub-model during training of the machine learning model

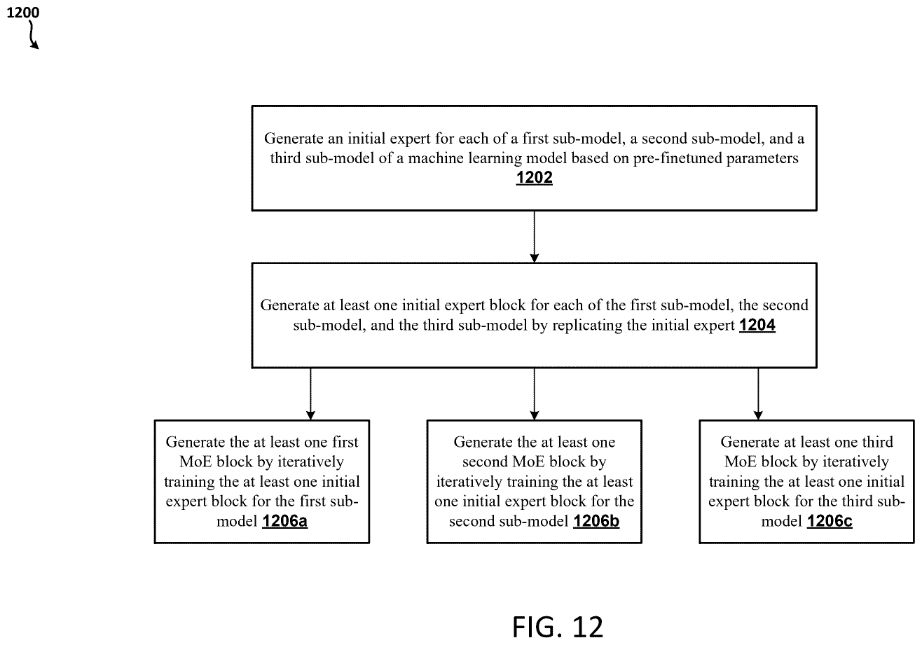

FIG. 12 shows an example process 1200 for training a machine learning model. Although depicted as a sequence of operations in FIG. 12, those of ordinary skill in the art will appreciate that various embodiments may add, remove, reorder, or modify the depicted operations.

A machine learning model (e.g., machine learning model 101) can be scaled up with upcycled MoE blocks (e.g., co-upcycled MoE 405) and trained under visual instruction tuning data in the third training stage. Scaling up the machine learning model with the upcycled MoE blocks can include adding at least one MoE block into each of a first sub-model (e.g., first sub-model 102), a second sub-model (e.g., second sub-model 104), and a third sub-model (e.g., third sub-model 106) of the machine learning model. Adding at least one MoE block into each of the first sub-model, the second sub-model, and the third sub-model can include generating an initial, well-trained expert for each of the first sub-model, the second sub-model and the third sub-model based on pre-finetuned parameters. At 1202, an initial expert can be generated for each of the first sub-model, the second sub-model, and the third sub-model of a machine learning model based on the pre-finetuned parameters of the machine learning model. For example, an initial expert in each MoE block of the first sub-model can be a MLP of the first sub-model that has been well-trained by the second pre-finetuning stage. An initial expert of the second sub-model can be a MLP of the second sub-model that has been well-trained by the first pre-training and second pre-finetuning stages. An initial expert in each MoE block of the third sub-model can be a MLP that has been well-trained by the second pre-finetuning stage.

At 1204, at least one initial expert block can be generated for each of the first sub-model, the second sub-model, and the third sub-model. The at least one initial expert block for each of the first sub-model, the second sub-model, and the third sub-model can be generated or obtained by replicating the initial expert for that sub-model. For example, the initial, well-trained expert for each of the first sub-model, the second sub-model, and the third sub-model can be replicated (e.g., copied) N times to generate at least one initial expert block for each of the first sub-model, the second sub-model, and the third sub-model.

Before training the machine learning model with visual instruction tuning data, the initial expert block in each of the first sub-model, the second sub-model, and the third sub-model can include N exact replicas of the corresponding initial expert. Then, the initial expert block in each of the first sub-model, the second sub-model, and the third sub-model can be iteratively trained during the third training stage. At 1206a, the at least one first MoE block (e.g., MoE block(s) 112) can be generated by iteratively training the at least one initial expert block for the first sub-model. At 1206b, the at least one second MoE block (e.g., MoE block(s) 114) can be obtained by iteratively training the at least one initial expert block for the second sub-model. At 1206c, the at least one third MoE block (e.g., MoE block(s) 116) can be generated by iteratively training the at least one initial expert block for the third sub-model. During each iteration, different experts can be activated to process different data. In this manner, by the end of the third training stage, the experts in each expert block will have different parameters.

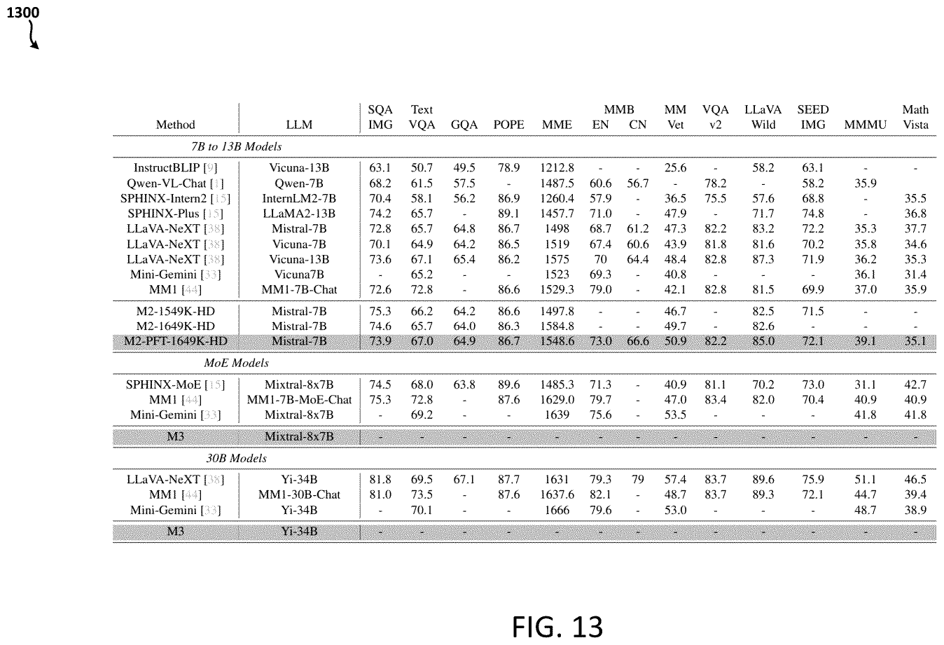

Experiments were conducted to evaluate the performance of the machine learning model 101. The performance of the machine learning model 101 was evaluated on multiple competitive benchmarks. Further, ablation studies were conducted on each of the first sub-model 102, the second sub-model 104, and the third sub-model 106 with upcycled MoE blocks. A comparison between the performance of the machine learning model 101 and other state-of-the-art instruction-following based multi-modality large language models is shown in the table 1300 of FIG. 13.

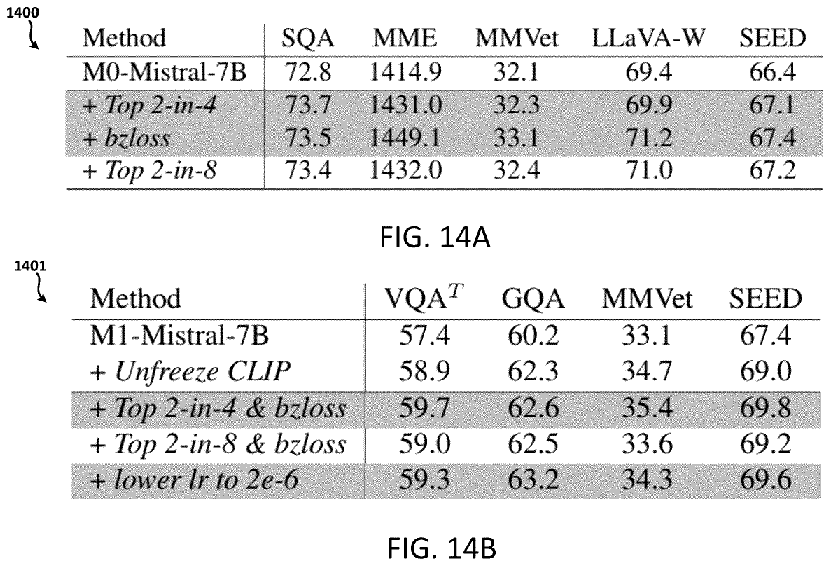

An ablation study was conducted on the second sub-model 104 with upcycled MoE blocks. The results are shown in the table 1400 of FIG. 14A. After setting up the baseline model, the MLP connector was replaced with an MLP with upcycled MoE blocks. The study began with a Top 2-in-4 router, which shows slight improvements over the baseline considering each expert only contains two linear layers. The bzloss was added to enable a balanced loading of experts in the MLP with upcycled MoE blocks, which shows clear improvements on benchmarks. An ablation study was conducted on the first sub-model 102 with upcycled MoE blocks. The results are shown in the table 1401 of FIG. 14B. First, the CLIP based on the MLP with upcycled MoE blocks was unfrozen. Clear improvements on VQA-based benchmarks were observed. Then, the MLP layers were replaced with sparsely-gated MoE layers in each feed-forward block with the top 2-in-4 router and bzloss during the visual instruction tuning stage. As shown in the table 1401, this further improves the performance. The learning rate was lowered to 2e-6, which is consistent with the learning rate of large language model as 2e-5 can cause training instabilities.

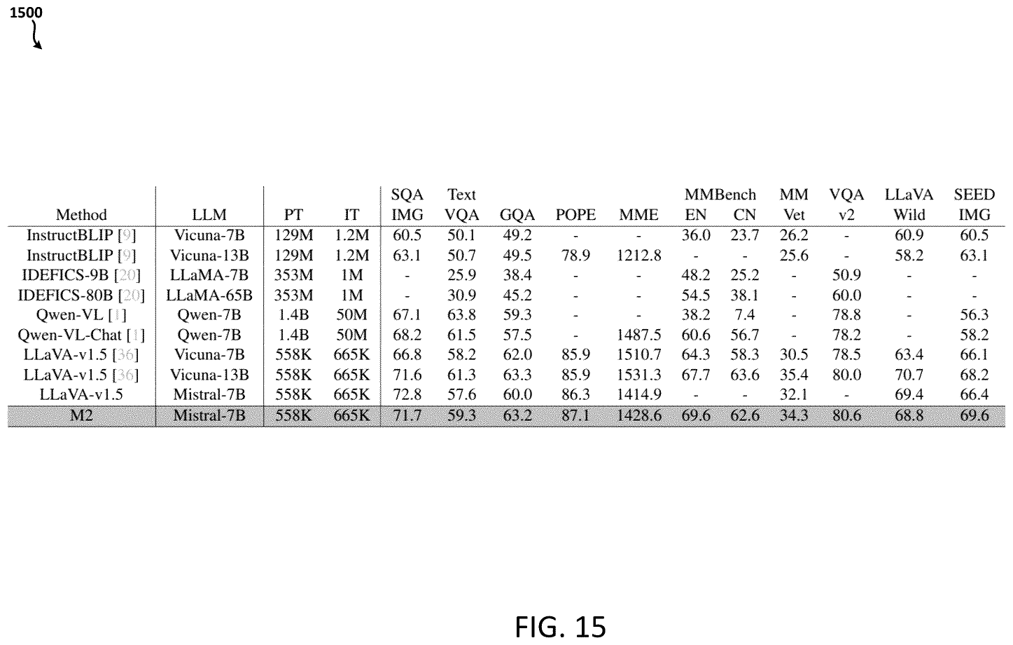

To further evaluate the effectiveness of the upcycled sparsely-gated MoE blocks in the first sub-model 102 and the second sub-model 104, the machine learning model 101 was evaluated under limited training data. The results are shown in the table 1500 of FIG. 15. As shown in the table 1500, the machine learning model 101 outperforms other 7B models.

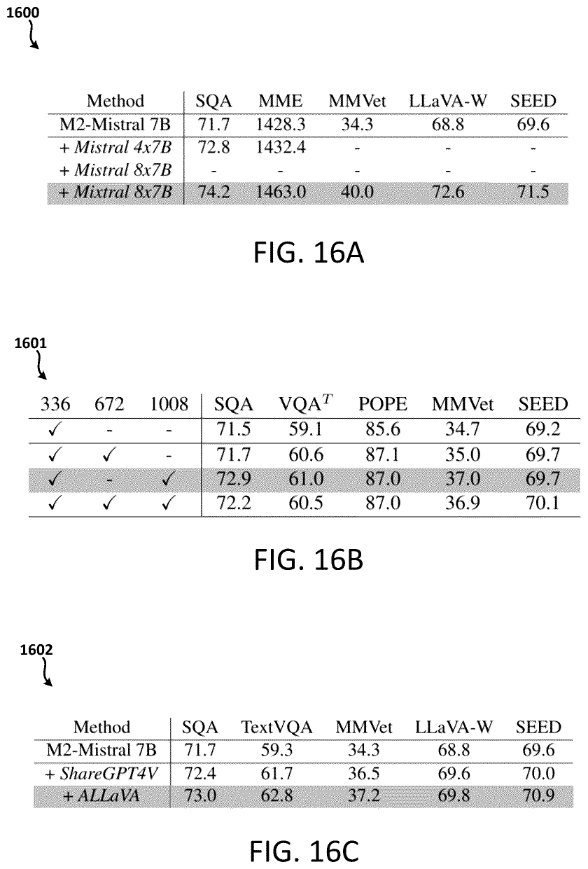

After replacing all MLP blocks with sparsely-gated MoE blocks in the visual part, the effect of using the MoE architecture in the third sub-model 106 was evaluated. Each MLP block in the third sub-model 106 was upcycled with a sparsely-gated MoE block. The weight of each expert was initialized from the pre-trained MLP block. The results shown in the table 1600 of FIG. 16A show that the upcycled models consistently outperform the other models.

As described above, multi-resolution inputs can be essential for multi-modality large language models to understand the content of images. Multi-resolution image features were applied as inputs to the first sub-model 102. The multi-resolution image features were concatenated channel-wise to keep the total number of the visual tokens the same as the low-resolution inputs. The table 1601 of FIG. 16B shows that a combination of 1008 (3×) and 336 (1×) is empirically the best for the performance of the machine learning model 101.

Previous ablation studies were based on visual instruction tuning directly after the pre-training of the MLP connector. Due to training instabilities during the process, it can be better to have the warm-up pre-finetuning stage before the visual instruction tuning. As a result, the pre-finetuning stage, which pre-fine tunes the machine learning model under high-quality image caption data, was added and all parameters of the machine learning model are unfrozen during the pre-finetuning stage. The results of the ablation study on the pre-finetuning stage are shown in table 1602 of FIG. 16C.

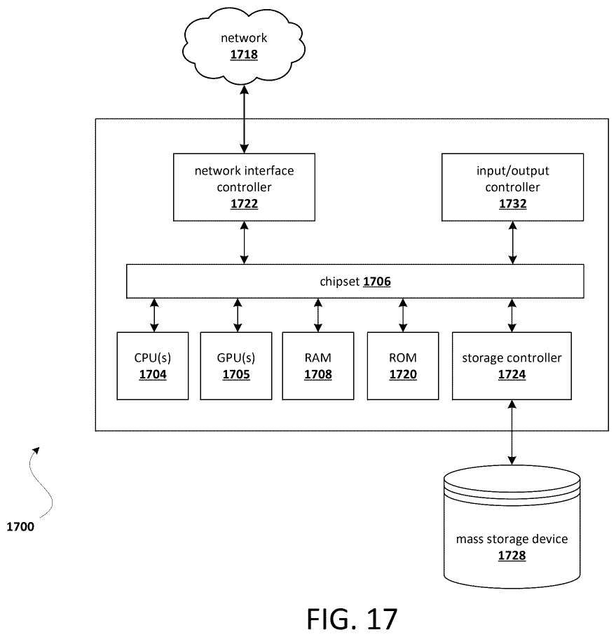

FIG. 17 illustrates a computing device that may be used in various aspects, such as the services, networks, modules, and/or devices depicted in any of FIGS. 1-4. With regard to FIGS. 1-4, any or all of the components may each be implemented by one or more instance of a computing device 1700 of FIG. 17. The computer architecture shown in FIG. 17 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1700 may include a baseboard, or “motherboard,” which is a printed circuit board to which a multitude of components or devices may be connected by way of a system bus or other electrical communication paths. One or more central processing units (CPUs) 1704 may operate in conjunction with a chipset 1706. The CPU(s) 1704 may be standard programmable processors that perform arithmetic and logical operations necessary for the operation of the computing device 1700.

The CPU(s) 1704 may perform the necessary operations by transitioning from one discrete physical state to the next through the manipulation of switching elements that differentiate between and change these states. Switching clements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1704 may be augmented with or replaced by other processing units, such as GPU(s) 1705. The GPU(s) 1705 may comprise processing units specialized for but not necessarily limited to highly parallel computations, such as graphics and other visualization-related processing.

A chipset 1706 may provide an interface between the CPU(s) 1704 and the remainder of the components and devices on the baseboard. The chipset 1706 may provide an interface to a random-access memory (RAM) 1708 used as the main memory in the computing device 1700. The chipset 1706 may further provide an interface to a computer-readable storage medium, such as a read-only memory (ROM) 1720 or non-volatile RAM (NVRAM) (not shown), for storing basic routines that may help to start up the computing device 1700 and to transfer information between the various components and devices. ROM 1720 or NVRAM may also store other software components necessary for the operation of the computing device 1700 in accordance with the aspects described herein.

The computing device 1700 may operate in a networked environment using logical connections to remote computing nodes and computer systems through local area network (LAN). The chipset 1706 may include functionality for providing network connectivity through a network interface controller (NIC) 1722, such as a gigabit Ethernet adapter. A NIC 1722 may be capable of connecting the computing device 1700 to other computing nodes over a network 1716. It should be appreciated that multiple NICs 1722 may be present in the computing device 1700, connecting the computing device to other types of networks and remote computer systems.

The computing device 1700 may be connected to a mass storage device 1728 that provides non-volatile storage for the computer. The mass storage device 1728 may store system programs, application programs, other program modules, and data, which have been described in greater detail herein. The mass storage device 1728 may be connected to the computing device 1700 through a storage controller 1724 connected to the chipset 1706. The mass storage device 1728 may consist of one or more physical storage units. The mass storage device 1728 may comprise a management component. A storage controller 1724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1700 may store data on the mass storage device 1728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1728 is characterized as primary or secondary storage and the like.

For example, the computing device 1700 may store information to the mass storage device 1728 by issuing instructions through a storage controller 1724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1700 may further read information from the mass storage device 1728 by detecting the physical states or characteristics of one or more particular locations within the physical storage units.

In addition to the mass storage device 1728 described above, the computing device 1700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1728 depicted in FIG. 17, may store an operating system utilized to control the operation of the computing device 1700. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1728 may store other system or application programs and data utilized by the computing device 1700.

The mass storage device 1728 or other computer-readable storage media may also be encoded with computer-executable instructions, which, when loaded into the computing device 1700, transforms the computing device from a general-purpose computing system into a special-purpose computer capable of implementing the aspects described herein. These computer-executable instructions transform the computing device 1700 by specifying how the CPU(s) 1704 transition between states, as described above. The computing device 1700 may have access to computer-readable storage media storing computer-executable instructions, which, when executed by the computing device 1700, may perform the methods described herein.

A computing device, such as the computing device 1700 depicted in FIG. 17, may also include an input/output controller 1732 for receiving and processing input from a number of input devices, such as a keyboard, a mouse, a touchpad, a touch screen, an electronic stylus, or other type of input device. Similarly, an input/output controller 1732 may provide output to a display, such as a computer monitor, a flat-panel display, a digital projector, a printer, a plotter, or other type of output device. It will be appreciated that the computing device 1700 may not include all of the components shown in FIG. 17, may include other components that are not explicitly shown in FIG. 17, or may utilize an architecture completely different than that shown in FIG. 17.

As described herein, a computing device may be a physical computing device, such as the computing device 1700 of FIG. 17. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of generating image descriptions using a machine learning model, comprising:
configuring the machine learning model by incorporating Mixture of Experts (MoE) blocks into a plurality of sub-models of the machine learning model, wherein a first sub-model of the machine learning model comprises at least one first MoE block, wherein the at least one first MoE block comprises a first plurality of experts, wherein a second sub-model of the machine learning model comprises at least one second MoE block, and wherein the at least one second MoE block comprises a second plurality of experts;
generating visual tokens by the first sub-model, wherein only a subset of the first plurality of experts is activated to generate the visual tokens based on an input image;
projecting the visual tokens by the second sub-model, wherein only a subset of the second plurality of experts is activated to project the visual tokens into an input space of a third sub-model of the machine learning model; and
outputting a text description of the input image by the third sub-model of the machine learning model, wherein the third sub-model is configured to generate descriptions of input images based on tokens projected in the input space of the third sub-model.

2. The method of claim 1, further comprising:
generating representations of the input image based on performing self-attention and normalization by the first sub-model; and
routing the representations of the input image to the activated subset of the first plurality of experts by a router of the at least one first MoE block.

3. The method of claim 1, further comprising:
generating the visual tokens by calculating a weighted sum of outputs from the activated subset of the first plurality of experts.

4. The method of claim 1, further comprising:
dividing the input image into patches;
generating a pyramid of high-resolution visual features based on the patches by the activated subset of the first plurality of experts; and
down-sampling the high-resolution visual features and performing channel-wise concatenation on the down-sampled high-resolution visual features.

5. The method of claim 1, further comprising:
routing the visual tokens to the activated subset of the second plurality of experts by a router of the at least one second MoE block;
processing the visual tokens by the activated subset of the second plurality of experts; and
calculating a weighted sum of outputs from the activated subset of the second plurality of experts.

6. The method of claim 1, wherein the third sub-model comprises at least one third MoE block, wherein the at least one third MoE block comprises a third plurality of experts, and wherein the method further comprises:
generating the text description of the input image by only a subset of the third plurality of experts.

7. The method of claim 1, further comprising:
receiving an input text query;
converting the input text query into an embedding in the input space of the third sub-model; and
generating the text description of the input image by the third sub-model based on the projected visual tokens and the embedding.

8. The method of claim 1, wherein the machine learning model is trained by utilizing a three-stage training process, and wherein the three-stage training process comprises:
pre-training the second sub-model while freezing the first sub-model and the third sub-model;
pre-finetuning parameters of the machine learning model; and
adding at least one MoE block into each of the first sub-model, the second sub-model, and the third sub-model and training the machine learning model on visual instruction tuning data.

9. The method of claim 8, wherein the adding at least one MoE block into each of the first sub-model, the second sub-model, and the third sub-model comprises:
generating an initial expert for each of the first sub-model, the second sub-model, and the third sub-model based on the pre-finetuned parameters; and
generating at least one initial expert block for each of the first sub-model, the second sub-model, and the third sub-model by replicating the initial expert.

10. The method of claim 9, further comprising:
generating the at least one first MoE block by iteratively training the at least one initial expert block for the first sub-model;
generating the at least one second MoE block by iteratively training the at least one initial expert block for the second sub-model; and
generating at least one third MoE block by iteratively training the at least one initial expert block for the third sub-model.

11. The method of claim 8, further comprising:
applying a loading balancing loss and a router-z loss to each of the first sub-model, the second sub-model, and the third sub-model to maintain a load balance between experts in each of the first sub-model, the second sub-model, and the third sub-model during training of the machine learning model.

12. A system of generating image descriptions using a machine learning model, comprising:
at least one processor; and
at least one memory communicatively coupled to the at least one processor and comprising computer-readable instructions that upon execution by the at least one processor cause the at least one processor to perform operations comprising:
configuring the machine learning model by incorporating Mixture of Experts (MoE) blocks into a plurality of sub-models of the machine learning model, wherein a first sub-model of the machine learning model comprises at least one first MoE block, wherein the at least one first MoE block comprises a first plurality of experts, wherein a second sub-model of the machine learning model comprises at least one second MoE block, and wherein the at least one second MoE block comprises a second plurality of experts;
generating visual tokens by the first sub-model, wherein only a subset of the first plurality of experts is activated to generate the visual tokens based on an input image;
projecting the visual tokens by the second sub-model, wherein only a subset of the second plurality of experts is activated to project the visual tokens into an input space of a third sub-model of the machine learning model; and
outputting a text description of the input image by the third sub-model of the machine learning model, wherein the third sub-model is configured to generate descriptions of input images based on tokens projected in the input space of the third sub-model.

13. The system of claim 12, the operations further comprising:
generating representations of the input image based on performing self-attention and normalization by the first sub-model;
routing the representations of the input image to the activated subset of the first plurality of experts by a router of the at least one first MoE block; and
generating the visual tokens by calculating a weighted sum of outputs from the activated subset of the first plurality of experts.

14. The system of claim 12, the operations further comprising:
routing the visual tokens to the activated subset of the second plurality of experts by a router of the at least one second MoE block;
processing the visual tokens by the activated subset of the second plurality of experts; and
calculating a weighted sum of outputs from the activated subset of the second plurality of experts.

15. The system of claim 12, wherein the machine learning model is trained by utilizing a three-stage training process, and wherein the three-stage training process comprises:
pre-training the second sub-model while freezing the first sub-model and the third sub-model;
pre-finetuning parameters of the machine learning model; and
adding at least one MoE block into each of the first sub-model, the second sub-model, and the third sub-model and training the machine learning model on visual instruction tuning data.

16. The system of claim 15, wherein the adding at least one MoE block into each of the first sub-model, the second sub-model, and the third sub-model comprises:
generating an initial expert for each of the first sub-model, the second sub-model, and the third sub-model based on the pre-finetuned parameters;
generating at least one initial expert block for each of the first sub-model, the second sub-model, and the third sub-model by replicating the initial expert; and
obtaining the at least one first MoE block of the first sub-model, the at least one second MoE block of the second sub-model, and at least one third MoE block of the third sub-model by iteratively training the at least one initial expert block for each of the first sub-model, the second sub-model, and the third sub-model.

17. A non-transitory computer-readable storage medium, storing computer-readable instructions that upon execution by a processor cause the processor to implement operations comprising:
configuring the machine learning model by incorporating Mixture of Experts (MoE) blocks into a plurality of sub-models of the machine learning model, wherein a first sub-model of the machine learning model comprises at least one first MoE block, wherein the at least one first MoE block comprises a first plurality of experts, wherein a second sub-model of the machine learning model comprises at least one second MoE block, and wherein the at least one second MoE block comprises a second plurality of experts;
generating visual tokens by the first sub-model, wherein only a subset of the first plurality of experts is activated to generate the visual tokens based on an input image;
projecting the visual tokens by the second sub-model, wherein only a subset of the second plurality of experts is activated to project the visual tokens into an input space of a third sub-model of the machine learning model; and
outputting a text description of the input image by the third sub-model of the machine learning model, wherein the third sub-model is configured to generate descriptions of input images based on tokens projected in the input space of the third sub-model.

18. The non-transitory computer-readable storage medium of claim 17, the operations further comprising:
generating representations of the input image based on performing self-attention and normalization by the first sub-model;
routing the representations of the input image to the activated subset of the first plurality of experts by a router of the at least one first MoE block; and
generating the visual tokens by calculating a weighted sum of outputs from the activated subset of the first plurality of experts.

19. The non-transitory computer-readable storage medium of claim 17, the operations further comprising:
routing the visual tokens to the activated subset of the second plurality of experts by a router of the at least one second MoE block;
processing the visual tokens by the activated subset of the second plurality of experts; and
calculating a weighted sum of outputs from the activated subset of the second plurality of experts.

20. The non-transitory computer-readable storage medium of claim 17, wherein the machine learning model is trained by utilizing a three-stage training process, and wherein the three-stage training process comprises:
pre-training the second sub-model while freezing the first sub-model and the third sub-model in a first training stage;
pre-finetuning parameters of the machine learning model in a second training stage; and
adding at least one MoE block into each of the first sub-model, the second sub-model, and the third sub-model and training the machine learning model on visual instruction tuning data in a third training stage.
